(19) United States
(12) Patent Application Publication
(10) Pub. No.: US 2004/0239566 A1
(43) Pub. Date: Dec. 2, 2004

(54) Antenna for dvb-t reception

(76) Inventors: Werner Blaier, Kolbermoor (DE); Udo Flinner, Reutlingen (DE)

Correspondence Address: NIXON & VANDERHYE, PC, 1100 N GLEBE ROAD, 8TH FLOOR, ARLINGTON, VA, 22201-4714, US

(21) Appl. No.: 10/487,142

(22) PCT Filed: Jul. 25, 2002
(86) PCT No.: PCT/EP02/08298

(30) Foreign Application Priority Data
Aug. 23, 2001 (DE) 101 41 256.8

(51) Int. Cl. H01Q 1/38; H01Q 1/24

(52) U.S. Cl. 343/700 MS; 343/702

(57) ABSTRACT

The invention relates to an improved antenna for DVB-T reception which is characterized in that the antenna consists of a plate-shaped flat antenna.

The invention relates to an antenna for DVB-T reception as claimed in the precharacterizing clause of claim 1.

As is known, it is planned that the transmission of broadcast radio and television signals will be changed completely from the analogue standard to the digital standard by 2010 at the latest. Transmissions will then be based on the Digital Video Broadcasting (DVB) Standard, which is suitable for digital reception of video and audio data via satellite, via cable or via terrestrially transmitted programs. The expressions DVB-S (for satellite reception), DVB-C (for cable reception) and DVB-T when the signals are transmitted terrestrially are used in a corresponding manner.

Receivers for DVB-T reception generally have rod antennas which are provided at the receiver, are connected, for example, by means of plugs to an interface and must have a specific length and a specific diameter to match the received frequency spectrum. Conventional rod antennas have a length of around 12 to 13 cm.

The object of the present invention is to provide an antenna which is better than and which can be produced easily.

According to the invention, the object is achieved by the features specified in claim 1. Advantageous refinements of the invention are specified in the dependent claims.

In contrast to rod omnidirectional antennas which are otherwise used, a flat antenna which is in the form of a plate is proposed according to the invention. In this case, the total area of the antenna is preferably of such a size that it corresponds to the surface area of a conventional rod antenna for the frequency transmission band under discussion for a corresponding DVB-T Standard.

In a development of the invention, the flat antenna which is in the form of a plate may be provided with edge sections which are in the form of flaps and which improve the matching.

Finally, it has been found to be advantageous for the flat antenna which is in the form of a plate to be designed as a type of printed circuit board which is provided, at least on one surface face, with a conductive layer which forms the antenna receiving surface. A corresponding interface in the form of a plug or of a socket can then be formed on this basic antenna material which is in the form of a printed circuit board, in order to connect the antenna formed in this way to a corresponding plug connection on the receiver itself.

The receiver itself or parts of the receiver housing may otherwise be used as an opposing surface.

The invention will be explained in more detail in the following text with reference to an exemplary embodiment. In this case, in detail:

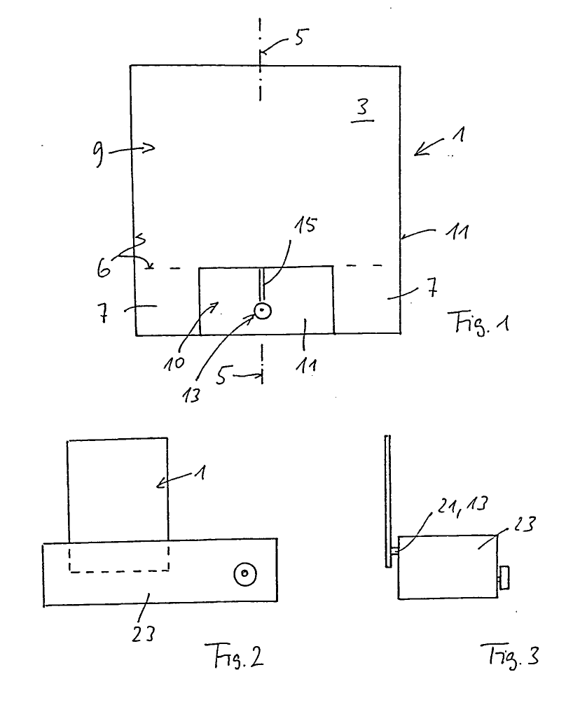

FIG. 1 shows a schematic side view over the complete area of a DVB-T antenna according to the invention;

FIG. 2 shows a corresponding illustration of a view of the front face of the antenna, as is plugged onto a rearward face of a receiver; and

FIG. 3 shows a side view, offset through 90°, of the antenna plugged onto the receiver in FIG. 2.

The drawings illustrate a flat antenna 1 which is in the form of a plate and may be composed of a conductive metal plate or metal sheet. It may also be produced from a dielectric mount, for example a mount material 11 which is in the form of a printed circuit board and on at least one face of which a metallically conductive layer 3 is formed. In the illustrated exemplary embodiment, the flat antenna which is in the form of a plate is in principle rectangular. In the illustrated exemplary embodiment, it has two coupling areas 7 to the left and to the right of a vertical axis of symmetry 5 in the left-hand and right-hand lower area adjacent to the rectangular shape 6 of the antenna 1 and, in the end, these lead to an enlargement of the total antenna area.

A plug arrangement 13 is formed in the non-conductive printed circuit board area, or other area, 10 of the mount material 11, between this coupling surface 7 and the upper large antenna section 9, and is electrically connected via an electrical connecting line 15 to the large antenna array section 9.

The flat antenna 1 which is in the form of a plate and is formed in this way can be plugged by means of its plug device 13 to, for example, a corresponding plug or socket arrangement 21 on the rear face of the receiver 23. The plug device not only holds the antenna 1, which is in the form of a plate, mechanically, but also connects it electrically to the receiver 23.

The antenna area is of such a size that it corresponds approximately to the surface area of a conventional rod antenna, for the frequency transmission band under discussion. A conventional rod antenna, for example, has a length of about 80 to 90 mm and a diameter of 8 to 9 mm, up to a length of 15 cm and a diameter of virtually 15 mm. Overall, in this case, the antenna area may then, for example, have values of 1000 mm² to 8000 mm², particularly when the antenna is operated in the DVB-T transmission band from 470 MHz to 872 MHz. If it is also intended to extend the transmission band in the direction of the VHF band, then the dimensions could be even larger.

Apart from the exemplary embodiment which is illustrated and has been explained, a modified form is also feasible, in which, for example, the antenna is not plugged directly into the receiver but is placed on and/or plugged to a separate stand foot. To this extent, the antenna may also be provided with a fixed stand foot. This stand foot may, for example, also contain an amplifier, which is connected to the receiver by an antenna connecting cable, and is supplied with power from the receiver. Thus, in an entirely general form, the antenna may be installed or fitted separately from the receiver, and is then connected to a receiver via an antenna cable or in the form of a repeater.

The antenna has been described for the situation in which the antenna element is completely flat and planar. However, if required, it is also possible for the antenna to have at least slight spherical curvature, for example slight cylindrical curvature about at least one axis, as well. However, the longitudinal and lateral extent of the antenna element, which is intrinsically kept flat and planar, in both extent directions of the planar or slightly curved antenna element is very much greater than its possible slight extent transversely with respect to this plane.

1. An antenna for DVB-T reception, characterized in that the antenna comprises a flat antenna which is in the form of a plate.

2. the antenna as claimed in claim 1, characterized in that the size of the surface of the flat antenna which is in the form of a plate corresponds to a comparable rod antenna, with a round cross section, for DVB-T reception.

3. The antenna as claimed in claim 1, characterized in that the antenna is essentially rectangular.

4. The antenna as claimed in claim 1, characterized in that the antenna preferably has coupling sections which are adjacent to the rectangular basic antenna section of the flat antenna (which is in the form of a plate), are located offset with respect to a vertical axis of symmetry or a vertical plane of symmetry, and enlarge the antenna areas.

5. The antenna as claimed in claim 1, characterized in that the antenna is formed from a metal plate.

6. The antenna as claimed in claim 1, characterized in that the antenna is formed on an isolating mount, preferably in the manner of a mount material which is in the form of a printed circuit board, with at least one surface or face of the isolating mount being provided with a metallization layer.

7. The antenna as claimed in claim 1 having an associated receiver, characterized in that the receiver or parts of it is or are used as an opposing surface.

8. The antenna as claimed in claim 1, characterized in that a plug arrangement is provided on the mount material, via which the flat antenna, which is in the form of a plate, can make electrical contact with and can be mechanically anchored to a receiver.

9. the antenna as claimed in claim 1, characterized in that the antenna has a stand, installation or suspension apparatus or is provided detachably with such an apparatus, in which case the antenna can be connected to the receiver via a separate antenna cable, or can be connected by radio in the form of a repeater.

10. The antenna as claimed in claim 9, characterized in that the antenna is mechanically and electrically connected, preferably by a coaxial plug connection, to a standard device or a stand foot, from which an antenna cable can be connected to a receiver.

11. The antenna as claimed in claim 9, characterized in that the antenna, an antenna housing and./or an installation or stand device are/is equipped with active or passive components, in particular for amplification, for attenuation or damping, or as a filter device.
